(19) United States
(12) Patent Application Publication
(10) Pub. No.: US 2017/0335510 A1
(43) Pub. Date: Nov. 23, 2017

(54) ODOR ADSORBENT COMPOSITION AND METHOD FOR USE IN POLYMERS

(71) Applicant: Microban Products Company, Huntersville, NC (US)

(72) Inventors: Karen Terry Welch, Kannapolis, NC (US); Ivan W. Ong, Charlotte, NC (US); Tian Lan, Huntersville, NC (US); Gina Parise Sloan, Statesville, NC (US)

(21) Appl. No.: 15/601,033

(22) Filed: May 22, 2017

Related U.S. Application Data
(60) Provisional application No. 62/340,316, filed on May 23, 2016.

(51) Int. Cl. D06M 15/59; C08G 73/00; C08G 73/02; D06M 15/00

(52) U.S. Cl. CPC D06M 15/59; D06M 15/00; C08G 73/00; C08G 73/0233

(57) ABSTRACT

A method of providing odor control to a natural fiber or a polymeric containing material and an odor control treated article are provided. The method comprises applying an odor adsorbing solution to the natural fiber or the polymeric containing material, wherein the odor adsorbing solution comprises an oxazoline homopolymer or an extended or a modified polymer based on an oxazoline homopolymer.

### CROSS-REFERENCE TO RELATED APPLICATION

The present application claims priority from U.S. provisional patent application 62/340,316, filed on May 23, 2016, incorporated by reference herein in its entirety.

### FIELD OF THE INVENTION

The present invention relates to an odor adsorbent composition and method, more particularly to an odor adsorbent composition and method for use with a polymeric material.

### BACKGROUND OF THE INVENTION

Odors in products of everyday use are a long-recognized issue. Odors are generated through the use and wear of clothing and shoes, as well as, through the spoilage of certain food products and microbial metabolism. Therefore, it would be advantageous to impart odor-adsorbing properties to a polymer or a polymeric material to combat the acquisition and build-up of odors in articles from the environment as well as everyday use.

Carboxylic acids are a common class of odorant molecules that bear a high odor impact. These odorants are found as key contributors to axillary or underarm sweat, as well as foot odor. They are also associated with food odors, including that of cheese. Carboxylic acids as a class are recognized to contribute a “wet and dirty dish-cloth” odor to washed and line-dried textiles. Carboxylic acids are also associated with the odors of rancid or spoiled food and vomit.

In addition, odors may linger in certain types of articles used in the home, such as polymer based items like trash cans, receptacles for soiled infant diapers, lunch boxes, cat litter boxes, and the like. Odorant molecules may also be attracted to certain types of textile fibers, including, cotton, polyester, and elastane.

Thus, it would be desirable to find a solution for reducing or eliminating these odors.

### SUMMARY OF THE INVENTION

In an embodiment of the invention, an odor adsorber compound or composition for use with polymers and polymeric materials is provided.

In order to address odors in items of everyday use, the odor adsorber compound or composition may be incorporated into or onto a filter medium or a textile. In addition, odor adsorber compound or composition may be added to articles or surfaces as a spray. The odor adsorber compound or composition may be incorporated into polymeric materials such as foams or plastic objects such as those composed of polyolefins.

In an embodiment of the invention, a method of using an odor adsorbent compound or composition within or applied to a natural fiber or polymeric containing material is provided. The natural fiber or polymeric containing material is preferably selected from the group consisting of cotton, rayon, wool, polyester, elastane, acrylic, modacrylic, nomex and blends thereof, as well as polypropylene, polyethylene (including in its various forms including high density polyethylene, low density polyethylene, and linear low density polyethylene), polycarbonate, melamine, acrylate-based polymers including poly methylmethacrylate, and polystyrene (and related polymers including acrylonitrile butadiene styrene, styrene acrylonitrile, and high impact polystyrene).

The odor adsorbent compound or composition can be used during manufacture, after manufacture, or both.

In an embodiment of the invention, an odor adsorbent compound is an oxazoline homopolymer or an extended or a modified polymer based on an oxazoline homopolymer.

In an embodiment of the invention, an odor adsorbent composition comprises an oxazoline homopolymer or an extended or a modified polymer based on an oxazoline homopolymer.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### DESCRIPTION OF THE PREFERRED EMBODIMENTS

The following description of the embodiments of the present invention is merely exemplary in nature and is in no way intended to limit the invention, its application, or uses. The present invention has broad potential application and utility, which is contemplated to be adaptable across a wide range of industries. The following description is provided herein solely by way of example for purposes of providing an enabling disclosure of the invention, but does not limit the scope or substance of the invention.

As used herein, the terms “microbe” or “microbial” should be interpreted to refer to any of the microscopic organisms studied by microbiologists or found in the use environment of a treated article. Such organisms include, but are not limited to, bacteria and fungi as well as other single-celled organisms such as mold, mildew and algae. Viral particles and other infectious agents are also included in the term microbe.

“Antimicrobial” further should be understood to encompass both microbicidal and microbistatic properties. That is, the term comprehends microbe killing, leading to a reduction in number of microbes, as well as a retarding effect of microbial growth, wherein numbers may remain more or less constant (but nonetheless allowing for slight increase/decrease).

For ease of discussion, this description uses the term antimicrobial to denote a broad spectrum activity (e.g. against bacteria and fungi). When speaking of efficacy against a particular microorganism or taxonomic rank, the more focused term will be used (e.g. antifungal to denote efficacy against fungal growth in particular).

Using the above example, it should be understood that efficacy against fungi does not in any way preclude the possibility that the same antimicrobial composition may demonstrate efficacy against another class of microbes.

For example, discussion of the strong bacterial efficacy demonstrated by a disclosed embodiment should not be read to exclude that embodiment from also demonstrating antifungal activity. This method of presentation should not be interpreted as limiting the scope of the invention in any way.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provided illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

In an embodiment of the invention, a method is provided for making an odor adsorbent polymeric article. The method comprises adding a compound or composition having odor adsorbent capabilities to a polymeric material. Examples of polymers include, but are not limited to, polypropylene, polyethylene (and its various forms including high density polyethylene, low density polyethylene, and linear low density polyethylene), polyester, nylon, elastane, polycarbonate, melamine, acrylate-based polymers including poly methylmethacrylate, and polystyrene (and related polymers including acrylonitrile butadiene styrene, styrene acrylonitrile, and high impact polystyrene).

In an embodiment of the invention, the compound is an oxazoline homopolymer. As another feature of the invention, the oxazoline homopolymer has the following structure:

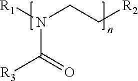

wherein

R₁ and R₂ are end groups determined by the polymerization techniques used to synthesize oxazoline homopolymer. R₁ and R₂ are independently selected and include, but are not limited to, hydrogen, alkyl, alkenyl, alkoxy, alkylamino, alkynyl, allyl, amino, anilino, aryl, benzyl, carboxyl, carboxyalkyl, carboxyalkenyl, cyano, glycosyl, halo, hydroxyl, oxazolinium mesylate, oxazolinium tosylate, oxazolinium triflate, silyl oxazolinium, phenolic, polyalkoxy, quaternary ammonium, thiol, or thioether groups. Alternatively, R₂ could include a macrocyclic structure formed during synthesis as a consequence of intramolecular attack.

For example, R₁ is a methyl group and R₂ is oxazolinium tosylate if methyl tosylate is used as the initiator in the cationic initiated polymerization of oxazoline.

R₃ is an end group determined by the type of oxazoline used in the preparation of the polymeric odor adsorber of this invention. R₃ includes, but is not limited to, hydrogen, alkyl, alkenyl, alkoxy, aryl, benzyl, hydroxyalkyl, or perfluoroalkyl. For example, R₃ is an ethyl group if ethyloxazoline is the monomer used to prepare the polymeric odor adsorber.

n is the degree of oxazoline polymerization in the homopolymer. n is in a range of 1 to 1,000,000. Preferably, n is in a range of 500 to 250,000; most preferably, n is in a range of 2500 to 100,000.

Similar to oxazoline homopolymer, extended or modified polymers with some variations based on the oxazoline homopolymer are also suitable for the present invention. The techniques and options for performing chemical or molecular structure variations or modifications to oxazoline should be familiar to those skilled in the art. A class of extended or modified polymers based on oxazoline homopolymer can be represented with the following molecular structure:

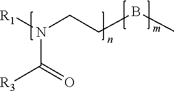

wherein

B is additional monomer repeating unit linked to oxazoline in a coploymer. The types of arrangement of the repeating units between B and oxazoline in the copolymer can include, but are not limited to, block, alternating, periodic, or combinations thereof. There is no limitation as to the types of B that can be used to copolymerize with or modify the oxazoline of the present invention.

n is the degree of polymerization for an oxazoline repeating unit; n in the copolymer is in a range of 1 to 1,000,000 and the degree of polymerization for B repeating unit in the copolymer m is in a range of 0 to 500,000 at the same time. Preferably, n is in a range of 50 to 250,000 and m is in a range of 20 to 10,000; and most preferably, n is in a range of 500 to 100,000 and m is in a range of 20 to 5,000. In addition to linking B to ethyloxazoline through copolymerization, B could also be linked to oxazoline as an end group in a cationic polymerization by using B as a cationic initiator if B itself is already a quaternary ammonium compound.

Not intended to be all inclusive, B can be, for example, ethyleneimine with the following molecular structure:

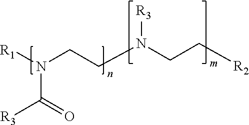

wherein

R₁ and R₂ end groups have the same definition as those outlined for oxazoline homopolymer.

R₃ includes, but is not limited to, hydrogen, alkyl, alkenyl, alkoxy, aryl, benzyl, hydroxyalkyl, or perfluoroalkyl.

R₄ includes, but is not limited to, hydrogen, alkyl, alkenyl, alkoxy, aryl, benzyl, hydroxyalkyl, or perfluoroalkyl.

m is in a range of 0 to 500,000; preferably, in a range of 20 to 10,000; and most preferably, in a range of 50 to 5,000.

n is in a range of 1 to 1,000,000; preferably, 500 to 250,000; most preferably, in a range of 2500 to 100,000.

The synthesis of oxazoline and ethyleneimine copolymer can be phased into two steps, for example. In a first step, a cationic ring opening polymerization technique can be used to make polyoxazoline homopolymer. In a second step, the polyoxazoline made in the first step can be hydrolyzed to convert part of polyoxazoline repeating units into polyethyleneimine. Alternatively, oxazoline-ethylenimine copolymer can be made with the appropriate respective monomers, an oxazoline and an aziridine. The result would be a cationic polymer having the above structure.

The degree of polymerization for oxazoline repeating unit n in the copolymer is in a range of 1 to 1,000,000 and the degree of polymerization for ethyleneimine repeating unit in the copolymer m is in a range of 0 to 500,000 at the same time. Preferably, n is in a range of 500 to 250,000 and m is in a range of 20 to 10,000, and most preferably n is in a range of 500 to 100,000 and m is in a range of 20 to 5,000.

Alternatively, the nitrogen in the ethyleneimine repeating unit could be further quaternized to generate the following cationic copolymer:

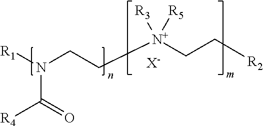

Any quaternization technique that is familiar to those skilled in the art could be used to quaternize the polymer of this example. R₁, R₂, R₃ and R₄ have the same meaning as those designated in the above oxazoline-ethyleneimine copolymer. R₅ includes, but is not limited to, a hydrogen, methyl, ethyl, propyl, or other types of alkyl group. The corresponding anion X⁻ is a halogen, sulfonate, sulfate, phosphonate, phosphate, carbonate/bicarbonate, hydroxy, or carboxylate.

The ranges for n and m are also the same as those described in oxazoline-ethyleneimine copolymer.

Another example of B that can be used for the present invention is polydiallyldimethylammonium chloride. Polyethyloxazoline modified with polydiallyldimethylammonium chloride has the following structure:

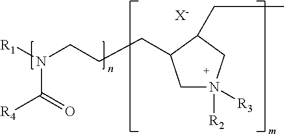

wherein

R₁ and R₄ have the same meaning as described in previous example for quaternized oxazoline-ethyleneimine copolymer.

R₂ and R₃, independently, include, but are not limited to, short chain alkyl groups such as C₁ to C₆. The corresponding anion X″ is a halogen, sulfonate, sulfate, phosphonate, phosphate, carbonate/bicarbonate, hydroxy, or carboxylate.

n and m are defined and numbered the same as in previous examples.

B could be other olefins including, but not limited to, diallyldimethylammonium chloride, styrene, methoxystyrene, and methoxyethene. Ethyloxazoline can also be copolymerized with heterocyclic monomers such as oxirane, thietane, 1,3-dioxepane, oxetan-2-one, and tetrahydrofuran to enhance the performance of the polymer for the present invention. The odor adsorber used in this invention could also employ pendant oxazoline groups on a polymer backbone, such as an acrylic or styrene based polymer, or a copolymer containing acrylic or styrene. B could be other olefins including, but not limited to, diallyldimethylammonium chloride, styrene, methoxystyrene, and methoxyethene. Ethyloxazoline can also be copolymerized with heterocyclic monomers such as oxirane, thietane, 1,3-dioxepane, oxetan-2-one, and tetrahydrofuran to enhance the performance of the polymer for the present invention. The odor adsorber used in this invention could also employ pendant oxazoline groups on a polymer backbone, such as an acrylic or styrene based polymer, or a copolymer containing acrylic or styrene.

Examples of commercially available polyethyloxazolines include, but are not limited to, Aquazol 500 from Polymer Chemistry Innovations, Inc.

In an embodiment of the invention, a method comprises adding the compound as a coating to an article or otherwise treating the article with the compound.

In an embodiment of the invention, the method comprises adding the compound to a polymer before or after formation of the polymeric article.

In an embodiment of the invention, the method comprises adding the compound to an integral part of the article.

In an embodiment of the invention, a composition is provided comprising the odor adsorbent compound and a biocidal agent. The compound and biocidal agent may be present in a matrix in which the biocidal agent is embedded to give comprehensive odor control and product protection.

Examples of biocidal agents suitable for use in the present invention include, but are not limited to, quaternary ammonium compounds, silver salts, silver ion-containing matrices or other sources of silver ion, copper, zinc salts, zinc oxide, zinc-containing organometallic compounds, diiodomethyl-p-tolylsulfone, isothiazoinones, 3-iodo-2-propynylbutylcarbamate, or phenolic compounds including o-phenylphenol and triclosan.

In an embodiment of the invention, the biocidal agent is a quaternary ammonium compound (QAC) with the following molecular structure:

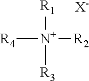

wherein

R₁, R₂, R₃, and R₄ are independently selected and include, but are not limited to, alkyl, alkoxy, or aryl, either with or without heteroatoms, or saturated or non-saturated. Some or all of the functional groups may be the same.

The corresponding anion X⁻ includes, but is not limited to, a halogen, sulfonate, sulfate, phosphonate, phosphate, carbonate/bicarbonate, hydroxy, or carboxylate.

QACs include, but are not limited to, n-alkyl dimethyl benzyl ammonium chloride, di-n-octyl dimethyl ammonium chloride, dodecyl dimethyl ammonium chloride, n-alkyl dimethyl benzyl ammonium saccharinate, and 3-(trimethoxysilyl) propyldimethyloctadecyl ammonium chloride.

Combinations of monomeric QACs are preferred to be used for the invention. A specific example of QAC combination is N-alkyl dimethyl benzyl ammonium chloride (40%); N-octyl decyl dimethyl ammonium chloride (30%); di-n-decyl dimethyl ammonium chloride (15%); and di-n-dioctyl dimethyl ammonium chloride (15%). The percentage is the weight percentage of individual QAC based on the total weight of blended QACs composition.

Polymeric version of the QACs with the following structures can also be used for the invention.

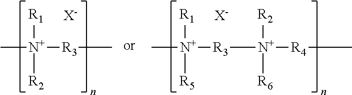

wherein

R₁, R₂, R₅, and R₆, independently, include, but are not limited to, hydrogen, methyl, ethyl, propyl or other longer carbon alkyl groups.

R₃ and R₄ are independently selected and include, but are not limited to, methylene, ethylene, propylene or other longer alkylene linking groups.

n is the degree of polymerization; n is an integer in a range of from 2 to 10,000.

Examples of cationic polymers with the above structure, include but are not limited to, polyamines derived from dimethylamine and epichlorohydrin such as Superfloc C-572 commercially available from Kemira Chemicals.

Still another polymeric QAC suitable for the invention is poly diallyldimethylammonium chloride or polyDADMAC.

Yet another class of QACs useful for the present invention are those chemical compounds with biguanide moiety in the molecule. Examples of this class of cationic antimicrobials include, but are not limited to, PHMB and chlorhexidine.

Examples of commercially available quaternary ammonium compounds include, but are not limited to, Bardac 205M and 208M from Lonza, and BTC885 from Stepan Company.

The present invention employs the polyoxazoline molecular framework as a platform for designing polymeric molecular structures that adsorb specific odors. By synthesis of specific variants of polyoxazoline polymers, odor adsorbers can be generated to address specific odors that are relevant to textile articles and to the home and office environments.

For example, the method and compound may be used in any polyolefin-based products in the home, office, industrial, or food preparation environment where odor is present, or in other polymeric articles in similar environments. In addition, if the polyoxazoline odor adsorber is added as a coating or as an integral part of the article, it may be used to provide a matrix in which antimicrobial compounds may be embedded to give comprehensive odor control and product protection.

In an embodiment of the invention, a polyoxazoline solution is applied to an article comprising a polymer. A polyoxazoline solution generally refers to an aqueous or ethanolic solution comprising a polyoxazoline. The polyoxazoline can be used in any concentration or state (solid, liquid, or gas). The polyoxazoline preferably has a concentration of 0.2% to 5% by mass based on the mass of the odor absorbing polyoxazoline solution, but the concentration could vary depending upon the molecular weight as well as the solubility properties of one or more copolymers, if present.

A polyoxazoline solution could be applied to a textile article such as polyester or other construction active wear textile to adsorb odors related to exercise, such as the carboxylic acids present in axillary odor. For example, a polyoxazoline solution could be applied to a cotton, polyester, or other construction sock material to adsorb foot odor, including carboxylic acids such as isovaleric acid. For example, a polyoxazoline solution could be applied to an insole, upper, or to other components of a shoe to adsorb foot odor, including carboxylic acids such as isovaleric acid.

The polyoxazoline solution may be pad-applied with an acrylate, silicone, or urethane binder to affix the solution to the textile article. Alternatively, the treatment could be used without a binder, applied by pad or exhaust.

As another alternative, the oxazoline could be compounded into a polymer-based shoe component, such as a foam insole, or a plastic shoe component.

The polyoxazoline solution could be used for other end use applications. For example, a polyoxazoline solution could be spray applied by a consumer to a home textile article, such as a couch, drapery, or carpet to adsorb odors related to spoiled food, cooking odors, vomit, or human body odor. In addition, the spray could also be applied to clothing or shoes for the same deodorizing effect.

A polyoxazoline solution could be applied to a non-woven filter material to adsorb food odor, such as the carboxylic acids produced from cheese or spoiled dairy products. The solution may be dip-, pad-, or spray-applied with or without the use of a latex binder.

A solid polyoxazoline could also be compounded into polypropylene or other food containers to impart an odor-adsorption property to these articles, specifically food-based odors. For example, the solid polyoxazoline could be compounded at a final letdown rate of 0.2% to 5% by mass.

An objective of structural modification through copolymer formation is to potentially get or adsorb other odorant molecules of different classes to potentially broaden odor adsorption. In an embodiment of the invention, a range of sidechains could be employed to tailor the odor adsorption properties of a copolymer or terpolymer comprised of 2-ethyl-2-oxazoline in addition to one or more of the following monomers: 2-methyl-2-oxazoline, 2-(carbazolyl)ethyl-2-oxazoline, 2-(2′-butoxy)ethyl-2-oxazoline, 2-2′-mercaptoethyl-2-oxazoline, 2-cyclo-propyl-2-oxazoline, 2-propyl-2-oxazoline, (am currently adding more), as well as resulting hydrolysis or synthesis products that can be prepared from the above described copolymers. Additional monomers and synthetic modifications thereto may be found in Rosegger, E.; Scheck, V; and Wiesbrock, F. Design Strategies for Functionalized Poly(2-oxazoline)s and Derived Materials, Polymers, 2013, 5, 956-1011, incorporated herein by reference.

### Examples

A commercially available polyoxazoline, Aquazol 500, was tested in a Method 1 and was found to have a surprisingly effective performance against carboxylic acids which is a class of odorants responsible for underarm odor, foot odor, rancid food/dairy odors, and others. Performance against other odorants was tested and, in the case of ammonia and trans-2 nonenal, odor adsorption relative to a standard polyester was also demonstrated.

In accordance with Odor Reduction Method 1 (MBI IVA 1), adsorption of isovaleric acid (IVA) by the oxazoline polymer was tested relative to an untreated polyester as a reference material. To 20-ml headspace vials containing either 30 mg of a reference textile material or 30 mg of a polyoxazoline polymer, a solution of isovaleric acid was added (sample vial). The amount of IVA added to the vial was 23 μg. In addition, the same amount of isovaleric acid was added to an empty vial as a reference (reference vial). Each vial was heated to 60° C. for one hour, and then a sample of the headspace gas was withdrawn and injected into a gas chromatograph-mass spectrometer (GCMS). The amount of isovaleric acid in each sample is measured by the instrument and represented as a peak area. The percent reduction of isovaleric acid was calculated as follows:

$$\% reduction = \frac{( Peak area reference vial - Peak area sample vial )}{Peak area reference vial} \times 100 \%$$

Results are shown in Table 1.

TABLE 1

| | Isovaleric acid (IVA) |
|---|---|
| Odorant | Method 1 (MBI IVA 1) |
| % reduction, untreated polyester (30 mg) | 20% |
| (% reduction is based on the performance | |
| relative to a reference vial containing no | |
| adsorber) | |
| % reduction, polyoxazoline (30 mg) | 91% |

Odor reduction for other odorants was tested, namely ammonia, 3-mercapto-3-methyl-1-butanol, and Trans-2-Nonenal.

In accordance with a Method 3, adsorption of ammonia (NH₃) by the oxazoline polymer was tested relative to an untreated polyester as a reference material. To a 3-L Tedlar bag with polypropylene valve was added 100 mg of a reference textile material or 100 mg of a polyoxazoline polymer, and the bag was sealed with tape. One liter of 100 ppm ammonia gas in nitrogen was added through the polypropylene valve (sample bag). An empty bag was prepared in a similar manner (reference bag). The bags were maintained at room temperature for two hours, and then a 100-ml sample of the headspace gas was withdrawn and the ammonia measured using a chemical-specific detector tube. The percent reduction of ammonia was calculated as follows:

$$\% reduction = \frac{( ppm {NH}_{3} reference bag - ppm {NH}_{3} sample bag )}{ppm {NH}_{3} reference bag} \times 100 \%$$

Results are shown in Table 2.

In accordance with a Method 4, adsorption of 3-mercapto-3-methyl-1-butanol (MMB) by the oxazoline polymer was tested relative to an untreated polyester as a reference material. To 20-ml headspace vials containing either 30 mg of a reference textile material or 30 mg of a polyoxazoline polymer, a solution of MMB was added (sample vial). The amount of IVA added to the vial was 5.0 μg. In addition, the same amount of MMB was added to an empty vial as a reference (reference vial). Each vial was heated to 60° C. for one hour, and then a sample of the headspace gas was withdrawn and injected into a gas chromatograph-mass spectrometer (GCMS). The amount of MMB in each sample was measured by the instrument and represented as a peak area. The percent reduction of MMB was calculated as follows:

$$\% reduction = \frac{( Peak area reference vial - Peak area sample vial )}{Peak area reference vial} \times 100 \%$$

Results are shown in Table 2.

In accordance with a Method 5, adsorption of trans-2-nonenal (NON) by the oxazoline polymer was tested relative to an untreated polyester as a reference material. To 20-ml headspace vials containing either 30 mg of a reference textile material or 30 mg of a polyoxazoline polymer, a solution of trans-2-nonenal was added (sample vial). The amount of trans-2-nonenal added to the vial was 22 μg. In addition, the same amount of isovaleric acid was added to an empty vial as a reference (reference vial). Each vial was heated to 60° C. for one hour, and then a sample of the headspace gas was withdrawn and injected into a gas chromatograph-mass spectrometer (GCMS). The amount of trans-2-nonenal in each sample is measured by the instrument and represented as a peak area. The percent reduction of trans-2-nonenal was calculated as follows:

$$\% reduction = \frac{( Peak area reference vial - Peak area sample vial )}{Peak area reference vial} \times 100 \%$$

Results are shown in Table 2.

TABLE 2

| | | 3-mercapto-3- | |
|---|---|---|---|
| | Ammonia | methyl-1-butanol | Trans-2-Nonenal |
| Odorant | (Method 3) | (Method 4) | (Method 5) |
| % reduction, | 11% | 7.5% | 68% |
| Lab standard | | | |
| polyester | | | |
| % reduction, | 0% | 1.5% | 84.5% |
| polyoxazoline | | | |

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method of providing odor control, the method comprising:
applying an odor adsorbing solution to a natural fiber or a polymeric containing material, wherein the odor adsorbing solution comprises an oxazoline homopolymer or an extended or a modified polymer based on an oxazoline homopolymer.

2. The method according to claim 1, wherein the odor absorbing solution is a polyoxazoline solution.

3. The method according to claim 2, wherein the polyoxazoline solution has a concentration of polyoxazoline in a range of 0.2% to 5% by mass based on the mass of polyoxazoline solution.

4. The method according to claim 1, wherein the polymeric containing material is a textile article or a non-woven filter material.

5. The method according to claim 1, wherein the natural fiber or the polymeric containing material having the odor adsorbing solution applied thereon adsorbs a carboxylic acid.

6. The method according to claim 1, wherein applying occurs by a method selected from the group consisting of dip, pad, spray, exhaust, and a combination thereof.

7. The method according to claim 1, wherein the odor adsorbing solution further comprises a binder.

8. The method according to claim 7, wherein the binder is selected from the group consisting of an acrylate binder, silicone binder, latex binder, urethane binder, and a combination thereof.

9. The method according to claim 1, wherein the natural fiber or the polymeric containing material is selected from the group consisting of wool, polyester, elastane, acrylic, modacrylic, nomex and blends thereof, polypropylene, polyethylene, polycarbonate, melamine, acrylate-based polymers, polystyrene, acrylonitrile butadiene styrene, styrene acrylonitrile, high impact polystyrene, and combinations thereof.

10. The method according to claim 1, wherein the natural fiber or polymeric containing material is an insole, upper, or other component of footwear.

11. The method according to claim 1, wherein the modified polymer based on the oxazoline homopolymer is a copolymer or terpolymer comprised of 2-ethyl-2-oxazoline and a monomer selected from the group consisting of 2-methyl-2-oxazoline, 2-(carbazolyl)ethyl-2-oxazoline, 2-(2′-butoxy)ethyl-2-oxazoline, 2-2′-mercaptoethyl-2-oxazoline, 2-cyclo-propyl-2-oxazoline, 2-propyl-2-oxazoline, a resulting hydrolysis or synthesis product prepared from the copolymer or terpolymer, and a combination thereof.

12. A method of providing odor control, the method comprising:
adding an odor adsorber to a polymeric containing material, wherein the odor adsorber comprises an oxazoline homopolymer or an extended or a modified polymer based on an oxazoline homopolymer.

13. The method according to claim 12, wherein addition occurs by compounding.

14. The method according to claim 12, wherein the odor adsorber is in a form of a solid.

15. The method according to claim 12, wherein the polymeric containing material is in a form of a textile article, a footwear component, a food container, or a carpet.

16. The method according to claim 12, wherein the modified polymer based on the oxazoline homopolymer is a copolymer or terpolymer comprised of 2-ethyl-2-oxazoline and a monomer selected from the group consisting of 2-methyl-2-oxazoline, 2-(carbazolyl)ethyl-2-oxazoline, 2-(2′-butoxy)ethyl-2-oxazoline, 2-2′-mercapto ethyl-2-oxazoline, 2-cyclo-propyl-2-oxazoline, 2-propyl-2-oxazoline, a resulting hydrolysis or synthesis product prepared from the copolymer or terpolymer, and a combination thereof.

17. An article comprising:
an odor adsorbent property from an odor adsorber,
wherein the odor adsorber comprises an oxazoline homopolymer or an extended or a modified polymer based on an oxazoline homopolymer.

18. The article according to claim 17, wherein the modified polymer based on the oxazoline homopolymer is a copolymer or terpolymer comprised of 2-ethyl-2-oxazoline and a monomer selected from the group consisting of 2-methyl-2-oxazoline, 2-(carbazolyl)ethyl-2-oxazoline, 2-(2′-butoxy)ethyl-2-oxazoline, 2-2′-mercapto ethyl-2-oxazoline, 2-cyclo-propyl-2-oxazoline, 2-propyl-2-oxazoline, a resulting hydrolysis or synthesis product prepared from the copolymer or terpolymer, and a combination thereof.

19. The article according to claim 17, wherein the article adsorbs a carboxylic acid.

20. The article according to claim 17, wherein the article is a textile article, footwear component, a food container, a carpet, or a non-woven filter material.
